(19) United States
(12) Patent Application Publication
(10) Pub. No.: US 2010/0121788 A1
(43) Pub. Date: May 13, 2010

(54) GENERATING A UTILIZATION CHARGE FOR A COMPUTER SYSTEM

(75) Inventors: Kalyanaraman Vaidyanathan, San Diego, CA (US); Steven F. Zwinger, Poway, CA (US); Kenny C. Gross, San Diego, CA (US); Aleksey M. Urmanov, San Diego, CA (US)

Correspondence Address: PVF -- SUN MICROSYSTEMS INC.;C/O PARK, VAUGHAN & FLEMING LLP, 2820 FIFTH STREET, DAVIS, CA, 95618-7759, US

(73) Assignee: SUN MICROSYSTEMS, INC., Santa Clara, CA (US)

(21) Appl. No.: 12/269,575

(22) Filed: Nov. 12, 2008

(51) Int. Cl. G06Q 30/00; G06Q 50/00

(52) U.S. Cl. 705/412; 705/400

(57) ABSTRACT

Some embodiments of the present invention provide a system that generates a utilization charge for a computer system. First, a set of performance parameters of the computer system are monitored. Next, a power utilization of the computer system is inferred based on the set of performance parameters and a power-utilization model. Then, a utilization charge is generated based on the power utilization of the computer system.

### BACKGROUND

1. Field

The present invention generally relates to techniques for characterizing the usage of a computer system. More specifically, the present invention relates to a method and an apparatus that generates a utilization charge for a computer system.

2. Related Art

It has been recently documented that throughout most of the computing industry, electricity utilization costs have overtaken equipment-plus-people costs as the largest component of the total cost of operation (TCO) of a datacenter. Therefore, in order for an information technology (IT) department in a company to hold business units accountable for the actual IT resources they consume, and foster cost efficiency as well as energy efficiency throughout the organization, it is important for the IT department to accurately track the electricity utilization costs involved in operating a computer system. However, many computer systems in use today do not have sensors that directly monitor the power used by a computer system, and installing such sensors on each computer system in a datacenter is often economically impractical.

Hence, what is needed is a method and system that generates a utilization charge for a computer system without the above-described problems.

### SUMMARY

Some embodiments of the present invention provide a system that generates a utilization charge for a computer system. First, a set of performance parameters of the computer system are monitored. Next, a power utilization of the computer system is inferred based on the set of performance parameters and a power-utilization model. Then, a utilization charge is generated based on the power utilization of the computer system.

In some embodiments, generating the utilization charge based on the power utilization includes determining an energy utilization based on the power utilization.

In some embodiments, generating the utilization charge based on the power utilization includes determining information related to a customer identity.

In some embodiments, generating the utilization charge includes determining an energy cost basis.

In some embodiments, estimating the power utilization of the computer system based on the set of performance parameters and the power-utilization model includes using a pattern-recognition technique.

In some embodiments, estimating the power utilization of the computer system based on the set of performance parameters and the power-utilization model includes using a nonlinear, nonparametric regression technique.

In some embodiments, estimating the power utilization of the computer system based on the set of performance parameters and the power-utilization model includes using a multivariate state estimation technique.

Some embodiments include training the power-utilization model, wherein training the power-utilization model includes measuring a power utilization of the computer system while the processor is operating at a first frequency and measuring a power utilization of the computer system while the processor is operating at a second frequency.

In some embodiments, the first frequency is a minimum frequency of operation of the processor and the second frequency is a maximum frequency of operation of the processor.

In some embodiments, monitoring the set of performance parameters of the computer system includes systematically monitoring and recording a set of performance parameters of the computer system, and the recording process keeps track of the temporal relationships between events in different performance parameters.

### BRIEF DESCRIPTION OF THE FIGURES

FIG. 1 represents a system that generates a utilization charge for a computer system in accordance with some embodiments of the present invention.

FIG. 2 presents a flow chart illustrating a process that generates a utilization charge for a computer system in accordance with some embodiments of the present invention.

FIG. 3 presents a flow chart illustrating a process that trains a model for inferring a power utilization for use in generating a utilization charge for a computer system in accordance with some embodiments of the present invention.

### DETAILED DESCRIPTION

The following description is presented to enable any person skilled in the art to make and use the disclosed embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present description. Thus, the present description is not intended to be limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

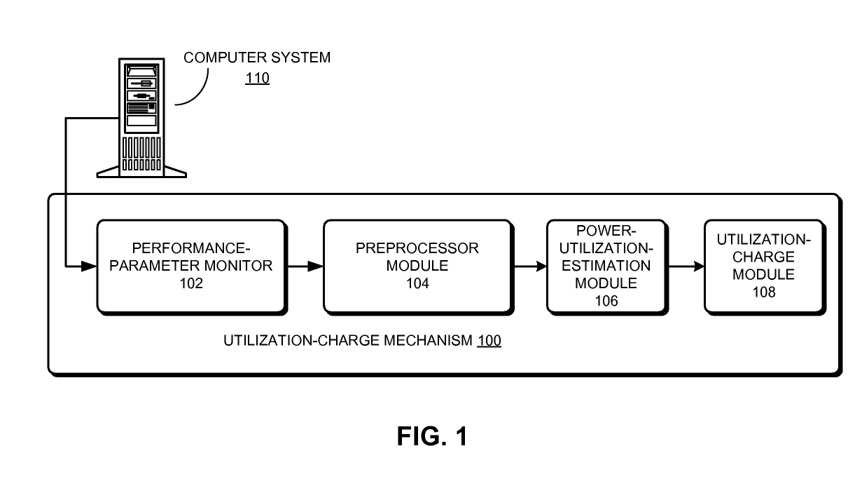

FIG. 1 represents a system that generates a utilization charge for a computer system in accordance with some embodiments of the present invention. Utilization-charge mechanism 100 includes performance-parameter monitor 102, preprocessor module 104, power-utilization-estimation module 106, and utilization-charge module 108. Furthermore, power-utilization-estimation mechanism 100 is coupled to computer system 110.

Performance-parameter monitor 102 can be any device that can monitor performance parameters of computer system 110, including but not limited to: temperatures, currents, voltages and fan speeds, performance metrics, loads, throughput variables, transaction latencies, and time series of any performance parameter. Performance parameters can also include but are not limited to performance parameters as set forth in U.S. Pat. No. 7,020,802, entitled “Method and Apparatus for Monitoring and Recording Computer System Performance Parameters,” by Kenny C. Gross and Larry G. Votta, Jr., issued on 28 Mar. 2006, which is hereby fully incorporated by reference.

Performance-parameter monitor 102 can be implemented in any combination of hardware and software. In some embodiments, performance-parameter monitor 102 operates on computer system 110. In other embodiments, performance-parameter monitor 102 operates on one or more service processors. In still other embodiments, performance-parameter monitor 102 is located inside of computer system 110. In yet other embodiments, performance-parameter monitor 102 operates on a separate computer system. In some embodiments, performance-parameter monitor 102 includes a method or apparatus for monitoring and recording computer system performance parameters as set forth in U.S. Pat. No. 7,020,802.

Preprocessor module 104 can be any device that can process performance parameter data received from performance-parameter monitor 102 into a form for input into power-utilization-estimation module 106. In some embodiments, preprocessor module 104 analytically re-samples the monitored performance parameters so that the monitored performance parameter data has a uniform sampling rate. In some embodiments, preprocessor module 104 is omitted, or operates on performance-parameter monitor 102 or power-utilization-estimation module 106. Preprocessor module 104 can be implemented in any combination of hardware and software. In some embodiments, preprocessor module 104 operates on computer system 110. In other embodiments, preprocessor module 104 operates on one or more service processors. In still other embodiments, preprocessor module 104 is located inside of computer system 110. In yet other embodiments, preprocessor module 104 operates on a separate computer system. In some embodiments, preprocessor module 104 implements techniques referred to and described in U.S. patent application entitled “Synchronizing Signals Related to the Operation of a Computer System,” by Kalyanaraman Vaidyanathan and Kenny C. Gross, Attorney Docket No. SUN08-0126, Ser. No. 12/101,321 filed on 11 Apr. 2008 which is hereby fully incorporated by reference.

Power-utilization-estimation module 106 receives input from preprocessor module 104 and infers the power utilization of computer system 110. Note that power-utilization-estimation module 106 can implement any pattern-recognition model, including but not limited to nonlinear, nonparametric regression such as a multivariate state estimation technique (MSET), a quadratic classifier, a k-nearest neighbor classifier, or an R-cloud classifier. Furthermore, note that the pattern-recognition model is generated during a training phase which is discussed in more detail below. Power-utilization-estimation module 106 can be implemented in any combination of hardware and software. In some embodiments, power-utilization-estimation module 106 operates on computer system 110. In other embodiments, power-utilization-estimation module 106 operates on one or more service processors. In still other embodiments, power-utilization-estimation module 106 is located inside of computer system 110. In yet other embodiments, power-utilization-estimation module 106 operates on a separate computer system.

Note that the term MSET as used in this specification refers to a class of pattern-recognition techniques. For example, see [Gribok] “Use of Kernel Based Techniques for Sensor Validation in Nuclear Power Plants,” by Andrei V. Gribok, J. Wesley Hines, and Robert E. Uhrig, The Third American Nuclear Society International Topical Meeting on Nuclear Plant Instrumentation and Control and Human-Machine Interface Technologies, Washington, D.C., Nov. 13-17, 2000. This paper outlines several different pattern-recognition approaches. Hence, the term MSET as used in this specification can refer to (among other things) any technique outlined in [Gribok], including: ordinary least squares (OLS), support vector machines (SVM), artificial neural networks (ANNs), MSET, or regularized MSET (RMSET).

Utilization-charge module 108 receives input from power utilization module 106 and generates a utilization charge for computer system 110. Utilization-charge module 108 can be implemented in any combination of hardware and software. In some embodiments, utilization-charge module 108 operates on computer system 110. In other embodiments, utilization-charge module 108 operates on one or more service processors. In still other embodiments, utilization-charge module 108 is located inside of computer system 110. In yet other embodiments, utilization-charge module 108 operates on a separate computer system. In some embodiments, utilization-charge module 108 generates a utilization charge (UC) based on a predetermined formula that can include but is not limited to:

UC=FC+EU*Cost per Unit of Energy (1)

In equation 1, the utilization charge, UC, is equal to the fixed cost, FC, plus the energy utilization, EU, multiplied by the cost per unit energy. In some embodiments, the fixed cost is based on the amortized cost of the equipment used to provide the service. The energy utilization, EU, is inferred based on the power utilization model. In some embodiments, the inferred power utilization generated by the power utilization model is multiplied by the time period between power utilization estimates, generating an energy utilization estimate for the time period between power utilization estimates. The energy utilization for the time period is then multiplied by the cost per unit energy to generate a cost for the energy used during the time period.

In some embodiments, the cost per unit energy is determined based on the actual cost for the energy used. For example, electrical utilities may provide electricity using different cost structures that may depend on factors including but not limited to one or more of: the amount of electricity contracted for, the time of day, the day of the week, and the time of year. For example, a company may have a fixed-price contract that has a maximum amount of power to be provided under the contact per month, and if the maximum is exceeded then the company pays a “spot market” rate. In some embodiments, the cost per unit energy in equation 1 is determined in other ways including but not limited to: an average over a predetermined period, an average that represents the average cost per unit energy for the time of day of the usage, the day of the week of the usage, or any other usage period desired. For example, a company may use a cost per unit energy in equation 1 that is equal to the average cost of electricity over a billing period for the time of day and day of the week that the usage takes place, so that any extra charges for electricity usage over a fixed-price maximum is distributed among all users to give each user the same incentive to reduce their usage. Furthermore, in some embodiments, the utilization charges determined using equation 1 for each customer are accumulated to generate a total utilization charge for the customer. Note that a customer can be defined in any way that is useful and relevant for the computer system operator, including but not limited to programs, people, groups, or departments, and can include internal and/or external customers.

Note that in some embodiments, power-utilization-estimation module 106 and/or utilization-charge mechanism 100 use one or more methods or systems referred to and described in U.S. patent application entitled “Inferential Power Monitor Without Voltage/Current Transducers,” by Kenny C. Gross, Kalyanaraman Vaidyanathan and Ramakrishna C. Dhanekula, Attorney Docket No. SUN05-0833, Ser. No. 11/205,924 filed on 17 Aug. 2005, which is hereby fully incorporated by reference, and U.S. patent application entitled “Estimating a Power Utilization of a Computer System,” by Andrew J. Lewis, Kalyanaraman Vaidyanathan and Kenny C. Gross, Attorney Docket No. SUN07-0848, Ser. No. 12/109,112 filed on 24 Apr. 2008, which is hereby fully incorporated by reference.

Furthermore, note that computer system 110 can include but is not limited to a server, server blade, a datacenter server, a field-replaceable unit, an enterprise computer, or any other computation system that includes one or more processors and one or more cores in each processor.

Some embodiments of the present invention operate as follows. During operation of computer system 110, performance-parameter monitor 102 monitors performance parameters of computer system 110. In some embodiments, the performance parameters that are monitored by performance-parameter monitor 102 are determined based on the performance parameters used to train the pattern-recognition model implemented by power-utilization-estimation module 106. Additionally, in some embodiments, a predetermined load script is run on computer system 110 when the performance parameters are monitored by performance-parameter monitor 102.

The monitored performance parameters are sent to preprocessor module 104 where they are analytically re-sampled to a uniform sampling rate. The preprocessed performance parameters are then sent to power-utilization-estimation module 106 and a power utilization estimate is inferred. The inferred power utilization is then sent to utilization-charge module 108 and a utilization charge is generated as discussed above. Note that in some embodiments, performance parameters or other information from computer system 110 and other sources may be transmitted to utilization-charge module 108 in order for utilization-charge module 108 to generate a utilization charge as discussed above. For example, in some embodiments, information identifying the customer associated with the program operating during the period corresponding to the utilization charge is transmitted to utilization-charge module 108 along with information related to the cost per unit energy of the energy being used.

We now turn to the training of the pattern-recognition model implemented by power-utilization-estimation module 106. A training data set is generated by monitoring the performance parameters of a training computer system along with the power used by the training computer system. Note that in some embodiments, the training computer system is the same as (or a similar computer system to) computer system 110. In some embodiments, a load script is run on the training computer system while the training data is collected. Then, the pattern-recognition model is trained using the training data.

In some embodiments, a subset of performance parameters is selected based on their correlation with the power utilization monitored for the training computer system. Additionally, note that in some embodiments, computer system 110 and the training computer system include dynamic power management features that can, for example, change the operating frequency of one or more of their processors. In these embodiments, the load script includes a sequence of instructions that produces a load profile that ranges from no load to a maximum load for both a first frequency and a second frequency for the processor in the computer system. In some embodiments, the first frequency is the minimum operation frequency for the processor, and the second frequency is the maximum operation frequency for the processor. The pattern-recognition model can then estimate the power consumption of the computer system when the processor in the computer system is operating at any frequency in the range from the first frequency to the second frequency used during the model-training process, with or without dynamic power-management features operating.

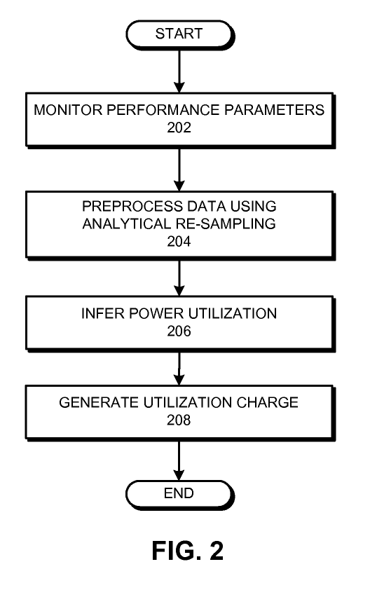

FIG. 2 presents a flow chart illustrating a process that generates a utilization charge for a computer system in accordance with some embodiments of the present invention. First, performance parameters are monitored (step 202) from the computer system. The performance parameter data is then preprocessed using analytical re-sampling (step 204). In some embodiments, step 204 is omitted. Next, the power utilization of the computer system is inferred (step 206). The inferred power utilization is generated using a power-utilization model trained during a training phase as described elsewhere. In some embodiments, the power-utilization model uses a pattern-recognition technique. In some embodiments, a nonlinear, nonparametric (NLNP) regression technique, such as the multivariate state estimation technique (MSET), is used. In other embodiments, other pattern-recognition techniques, such as neural networks or other types of NLNP regression, are used. Then, a utilization charge is generated (step 208) based on the inferred power utilization as discussed in detail above.

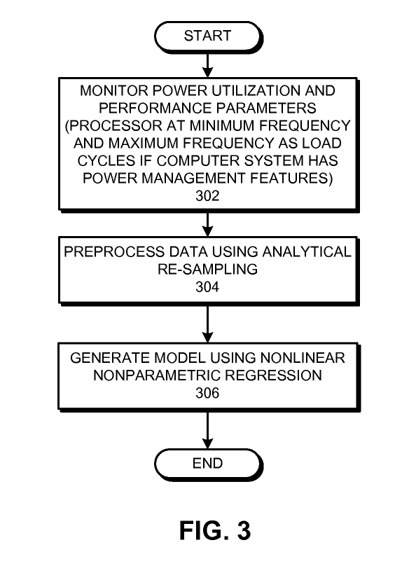

FIG. 3 presents a flow chart illustrating a process that trains a model for inferring a power utilization for use in generating a utilization charge for a computer system in accordance with some embodiments of the present invention. First, power utilization and performance parameters for a computer system are monitored. If the computer system uses power-management features, then the performance parameters and power utilization are monitored when a processor in the computer system is at a minimum operation frequency as the load on the processor is varied from a minimum load to a maximum load, and when the processor in the computer system is at a maximum operation frequency as the load on the processor is varied from a minimum load to a maximum load (step 302). The data is then preprocessed using analytical re-sampling (step 304). Then a power-utilization model is generated using nonlinear, nonparametric regression (step 306).

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method for generating a utilization charge for a computer system, the method comprising:
monitoring a set of performance parameters of the computer system;
inferring a power utilization of the computer system based on the set of performance parameters and a power-utilization model; and
generating a utilization charge based on the power utilization of the computer system.

2. The method of claim 1, wherein generating the utilization charge based on the power utilization includes determining an energy utilization based on the power utilization.

3. The method of claim 1, wherein generating the utilization charge based on the power utilization includes determining information related to a customer identity.

4. The method of claim 1, wherein generating the utilization charge includes determining an energy cost basis.

5. The method of claim 1, wherein estimating the power utilization of the computer system based on the set of performance parameters and the power-utilization model includes using a pattern-recognition technique.

6. The method of claim 1, wherein estimating the power utilization of the computer system based on the set of performance parameters and the power-utilization model includes using a nonlinear, nonparametric regression technique.

7. The method of claim 6, wherein estimating the power utilization of the computer system based on the set of performance parameters and the power-utilization model includes using a multivariate state estimation technique.

8. The method of claim 1, further including training the power-utilization model, wherein training the power-utilization model includes measuring a power utilization of the computer system while the processor is operating at a first frequency and measuring a power utilization of the computer system while the processor is operating at a second frequency.

9. The method of claim 8, wherein the first frequency is a minimum frequency of operation of the processor and the second frequency is a maximum frequency of operation of the processor.

10. The method of claim 1,
wherein monitoring the set of performance parameters of the computer system includes systematically monitoring and recording a set of performance parameters of the computer system; and
wherein the recording process keeps track of the temporal relationships between events in different performance parameters.

11. A computer-readable storage medium storing instructions that when executed by a computer cause the computer to perform a method for generating a utilization charge for a computer system, the method comprising:
monitoring a set of performance parameters of the computer system;
inferring a power utilization of the computer system based on the set of performance parameters and a power-utilization model; and
generating a utilization charge based on the power utilization of the computer system.

12. The computer-readable storage medium of claim 11, wherein generating the utilization charge based on the power utilization includes determining an energy utilization based on the power utilization.

13. The computer-readable storage medium of claim 11, wherein generating the utilization charge based on the power utilization includes determining information related to a customer identity.

14. The computer-readable storage medium of claim 11, wherein generating the utilization charge includes determining an energy cost basis.

15. The computer-readable storage medium of claim 11, wherein estimating the power utilization of the computer system based on the set of performance parameters and the power-utilization model includes using a pattern-recognition technique.

16. The computer-readable storage medium of claim 11, wherein estimating the power utilization of the computer system based on the set of performance parameters and the power-utilization model includes using a nonlinear, nonparametric regression technique.

17. The computer-readable storage medium of claim 16, wherein estimating the power utilization of the computer system based on the set of performance parameters and the power-utilization model includes using a multivariate state estimation technique.

18. The computer-readable storage medium of claim 11, further including training the power-utilization model, wherein training the power-utilization model includes measuring a power utilization of the computer system while the processor is operating at a minimum frequency and measuring a power utilization of the computer system while the processor is operating at a maximum frequency.

19. The computer-readable storage medium of claim 11,
wherein monitoring the set of performance parameters of the computer system includes systematically monitoring and recording a set of performance parameters of the computer system; and
wherein the recording process keeps track of the temporal relationships between events in different performance parameters.

20. An apparatus that generates a utilization charge for a computer system, the apparatus comprising:
a monitoring mechanism configured to monitor a set of performance parameters of the computer system;
an inferring mechanism configured to infer a power utilization of the computer system based on the set of performance parameters and a power-utilization model; and
a generating mechanism configured to generate a utilization charge based on the power utilization of the computer system.
